(19) United States
(12) Patent Application Publication
(10) Pub. No.: US 2026/0040133 A1
(43) Pub. Date: Feb. 5, 2026

(54) MULTI-FLOW PRIORITIZATION AND SHAPING

(71) Applicant: InterDigital Patent Holdings, Inc., Wilmington, DE (US)

(72) Inventors: Faris Alfarhan, Montreal (CA); Tuong Duc Hoang, Montreal (CA); Ghyslain Pelletier, Montreal (CA); Francois Periard, Montreal (CA); Tejaswinee Lutchoomun, Montreal (CA)

(73) Assignee: InterDigital Patent Holdings, Inc., Wilmington, DE (US)

(21) Appl. No.: 18/794,322

(22) Filed: Aug. 5, 2024

(51) Int. Cl. H04W 28/02; H04W 28/08

(52) U.S. Cl. CPC H04W 28/0268; H04W 28/0858; H04W 72/1263; H04W 72/1268

(57) ABSTRACT

Systems, methods, and instrumentalities are described herein associated with multi-flow prioritization and shaping. Per packet treatment for traffic shaping (e.g., UL traffic shaping) may be performed. Per packet treatment for traffic shaping may be performed based on a characteristic/condition associated with a data packet. Per packet treatment for traffic shaping may be performed based on a network signaling. Exclusion from traffic shaping may be determined, for example, on a per packet basis (e.g., based on a characteristic/condition associated with a data packet).

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein associated with multi-flow prioritization and shaping. Per packet treatment for traffic shaping (e.g., UL traffic shaping) may be performed. Per packet treatment for traffic shaping may be performed based on a characteristic/condition associated with a data packet. Per packet treatment for traffic shaping may be performed based on a network signaling. Exclusion from traffic shaping may be determined, for example, on a per packet basis (e.g., based on a characteristic/condition associated with a data packet).

A wireless transmit/receive unit (WTRU) may perform multi-flow prioritization and shaping. The WTRU may perform traffic shaping per packet. The WTRU may determine a set of traffic shaping parameters per data packet for a data flow. For example, the WTRU may receive configuration information comprising a first set of traffic shaping parameters and a second set of traffic shaping parameters. The first set of traffic shaping parameters may be associated with a first quality of service (QoS) classifier. The second set of traffic shaping parameters may be associated with a second QoS classifier. The traffic shaping parameters may include one or more of the following: a rate (e.g., fill rate), a burst size, a peak rate, a bucket size, a number of buckets, an envelope. The set of traffic shaping parameters may be associated with a QoS treatment profile and/or a QoE treatment profile. The WTRU may receive an uplink grant for transmission. The WTRU may determine a QoS classifier associated with a data packet. The determined QoS classifier may be associated with one or more of a packet type, a priority, a QoS treatment profile, a quality of experience (QoE) treatment profile, a data interaction, or a transport layer protocol. The QoS classifier may be determined based on whether a condition associated with the data packet is satisfied. The QoS classifier may be the first QoS classifier or the second QoS classifier. The WTRU may multiplex data associated with the data flow based on a set of traffic shaping parameters associated with the determined QoS classifier. The set of traffic shaping parameters associated with multiplexing data associated with the data flow may be the first set of traffic shaping parameters or the second set of traffic shaping parameters. The WTRU may send the multiplexed data, for example, using the uplink grant.

A wireless transmit/receive unit (WTRU) may perform multi-flow prioritization and shaping. The WTRU may perform traffic shaping per packet. The WTRU may determine a set of traffic shaping parameters per data packet for a data flow. For example, the WTRU may receive configuration information comprising a first set of traffic shaping parameters and a second set of traffic shaping parameters. The WTRU may determine a third set of traffic shaping parameters for a first data packet in the data flow. The WTRU may determine a fourth set of traffic shaping parameters for a second data packet in the data flow. The third set of traffic shaping parameters and the fourth set of traffic shaping parameters may be the first set of traffic shaping parameters or the second set of traffic shaping parameters. The third set of traffic shaping parameters may be different from the fourth set of traffic shaping parameters. The WTRU may multiplex data associated with the data flow on the uplink grant, for example, based on the third set of traffic shaping parameters and the fourth set of traffic shaping parameters.

For example, the WTRU may determine a first characteristic/condition associated with the first data packet and a second characteristic/condition associated with the second data packet. The third set of traffic shaping parameters for the first data packet may be determined based on the first characteristic/condition. The fourth set of traffic shaping parameters for the second data packet may be determined based on the second characteristic/condition. The first characteristic and/or second characteristic may be associated with one or more of the following: a packet type, a priority, a quality of service (QoS) treatment profile, a quality of experience (QoE) treatment profile, a data interaction, a transport layer protocol, etc.

For example, the WTRU may receive (e.g., from a network entity) an indication (e.g., a first indication and a second indication) associated with traffic shaping. The third set of traffic shaping parameters and/or the fourth set of traffic shaping parameters may be determined based on the indication (e.g., the third set of traffic shaping parameters may be determined based on a first indication and/or the fourth set of traffic shaping parameters may be determined based on a second indication). The indication may be received, for example, via signaling from the network entity or a downlink control information (DCI). The indication may indicate a duration associated with applying a set of traffic shaping parameters. The indication may be associated with an uplink grant (e.g., specific uplink grant).

The WTRU may determine an exclusion/exception to traffic shaping for a data packet. The WTRU may determine that a first data packet is associated with a traffic shaping exception and/or the WTRU may determine that a second data packet is associated with a traffic shaping exception. The exception may be determined based on a characteristic associated with the data packet. The WTRU may multiplex data associated with a data flow based on whether a data packet is associated with an exception to traffic shaping.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example a traffic scheduling regulator “S”.

FIG. 3 illustrates an example UL traffic Arrival and Departure function at the WTRU buffer.

FIG. 4 illustrates an example prioritization between N data flows competing for UL resources on a grant of size C.

FIG. 5 illustrates an example leaky bucket traffic departure shaper.

FIG. 6 illustrates an example dual leaky bucket traffic departure shaper.

FIG. 7 illustrates an example data plane architecture framework.

FIG. 8 illustrates an example of traffic shaping for a data flow.

### DETAILED DESCRIPTION

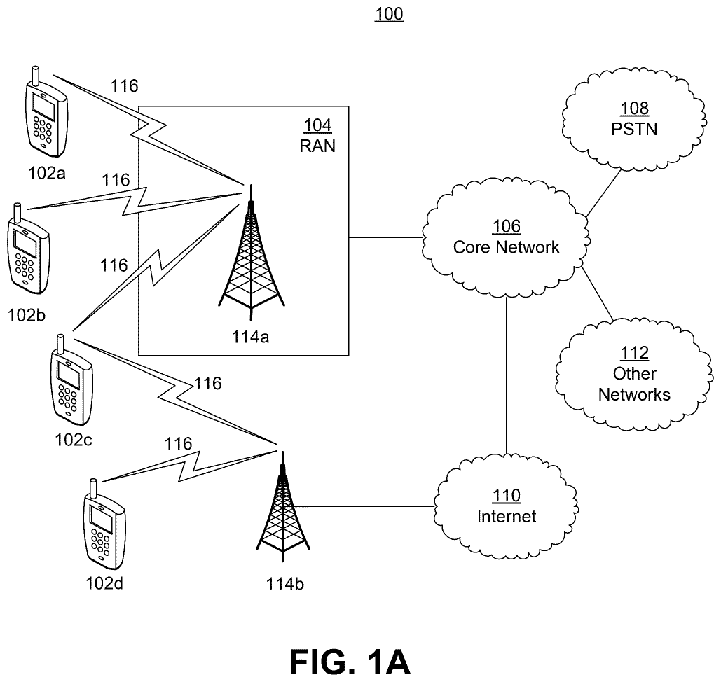

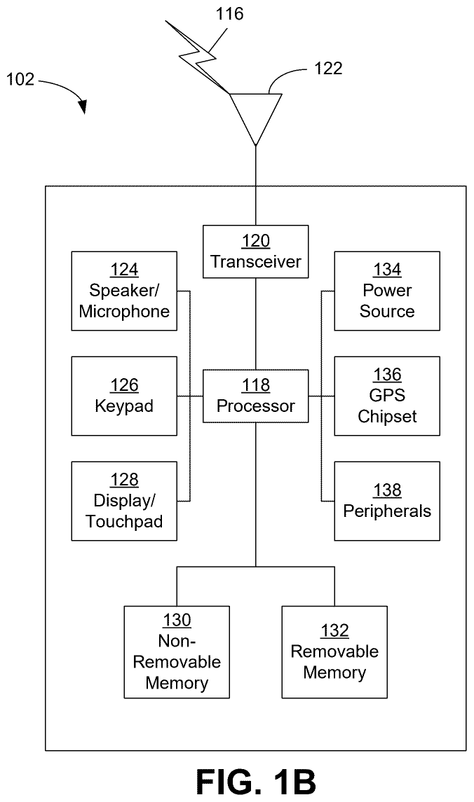

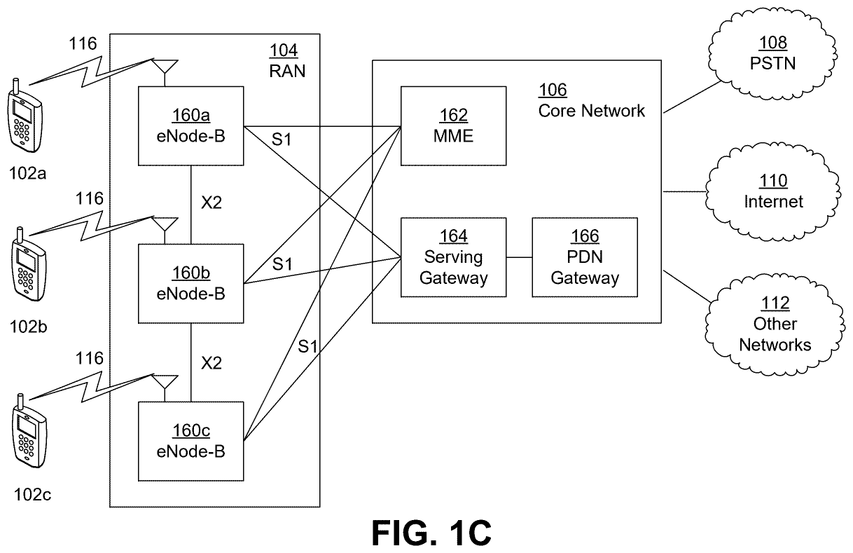

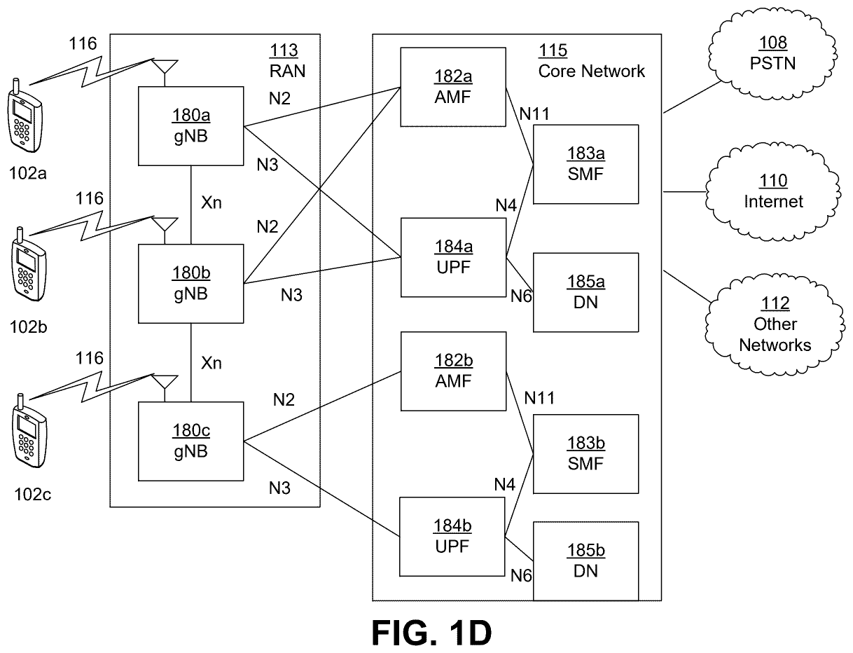

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although features and elements described above are described in particular combinations, each feature or element may be used alone without the other features and elements of the preferred embodiments, or in various combinations with or without other features and elements.

Systems, methods, and instrumentalities are described herein associated with multi-flow prioritization and shaping. Per packet treatment for traffic shaping (e.g., UL traffic shaping) may be performed. Per packet treatment for traffic shaping may be performed based on a characteristic/condition associated with a data packet. Per packet treatment for traffic shaping may be performed based on a network signaling. Exclusion from traffic shaping may be determined, for example, on a per packet basis (e.g., based on a characteristic/condition associated with a data packet).

A wireless transmit/receive unit (WTRU) may perform multi-flow prioritization and shaping. The WTRU may perform traffic shaping per packet. The WTRU may determine a set of traffic shaping parameters per data packet for a data flow. For example, the WTRU may receive configuration information comprising a first set of traffic shaping parameters and a second set of traffic shaping parameters. The first set of traffic shaping parameters may be associated with a first quality of service (QoS) classifier. The second set of traffic shaping parameters may be associated with a second QoS classifier. The traffic shaping parameters may include one or more of the following: a rate (e.g., fill rate), a burst size, a peak rate, a bucket size, a number of buckets, an envelope. The set of traffic shaping parameters may be associated with a QoS treatment profile and/or a QoE treatment profile. The WTRU may receive an uplink grant for transmission. The WTRU may determine a QoS classifier associated with a data packet. The determined QoS classifier may be associated with one or more of a packet type, a priority, a QoS treatment profile, a quality of experience (QoE) treatment profile, a data interaction, or a transport layer protocol. The QoS classifier may be determined based on whether a condition associated with the data packet is satisfied. The QoS classifier may be the first QoS classifier or the second QoS classifier. The WTRU may multiplex data associated with the data flow based on a set of traffic shaping parameters associated with the determined QoS classifier. The set of traffic shaping parameters associated with multiplexing data associated with the data flow may be the first set of traffic shaping parameters or the second set of traffic shaping parameters. The WTRU may send the multiplexed data, for example, using the uplink grant.

A wireless transmit/receive unit (WTRU) may perform multi-flow prioritization and shaping. The WTRU may perform traffic shaping per packet. The WTRU may determine a set of traffic shaping parameters per data packet for a data flow. For example, the WTRU may receive configuration information comprising a first set of traffic shaping parameters and a second set of traffic shaping parameters. The WTRU may determine a third set of traffic shaping parameters for a first data packet in the data flow. The WTRU may determine a fourth set of traffic shaping parameters for a second data packet in the data flow. The third set of traffic shaping parameters and the fourth set of traffic shaping parameters may be the first set of traffic shaping parameters or the second set of traffic shaping parameters. The third set of traffic shaping parameters may be different from the fourth set of traffic shaping parameters. The WTRU may multiplex data associated with the data flow on the uplink grant, for example, based on the third set of traffic shaping parameters and the fourth set of traffic shaping parameters.

For example, the WTRU may determine a first characteristic/condition associated with the first data packet and a second characteristic/condition associated with the second data packet. The third set of traffic shaping parameters for the first data packet may be determined based on the first characteristic/condition. The fourth set of traffic shaping parameters for the second data packet may be determined based on the second characteristic/condition. The first characteristic and/or second characteristic may be associated with one or more of the following: a packet type, a priority, a quality of service (QoS) treatment profile, a quality of experience (QoE) treatment profile, a data interaction, a transport layer protocol, etc.

For example, the WTRU may receive (e.g., from a network entity) an indication (e.g., a first indication and a second indication) associated with traffic shaping. The third set of traffic shaping parameters and/or the fourth set of traffic shaping parameters may be determined based on the indication (e.g., the third set of traffic shaping parameters may be determined based on a first indication and/or the fourth set of traffic shaping parameters may be determined based on a second indication). The indication may be received, for example, via signaling from the network entity or a downlink control information (DCI). The indication may indicate a duration associated with applying a set of traffic shaping parameters. The indication may be associated with an uplink grant (e.g., specific uplink grant).

The WTRU may determine an exclusion/exception to traffic shaping for a data packet. The WTRU may determine that a first data packet is associated with a traffic shaping exception and/or the WTRU may determine that a second data packet is associated with a traffic shaping exception. The exception may be determined based on a characteristic associated with the data packet. The WTRU may multiplex data associated with a data flow based on whether a data packet is associated with an exception to traffic shaping.

Details associated with traffic shaping and regulation may be described herein.

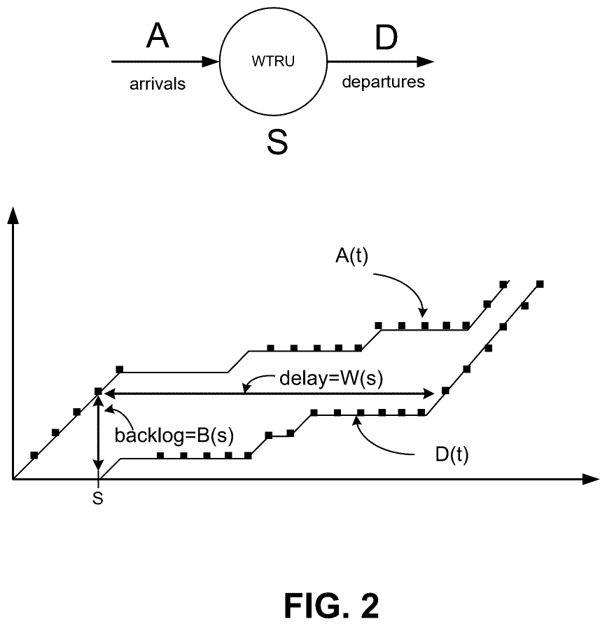

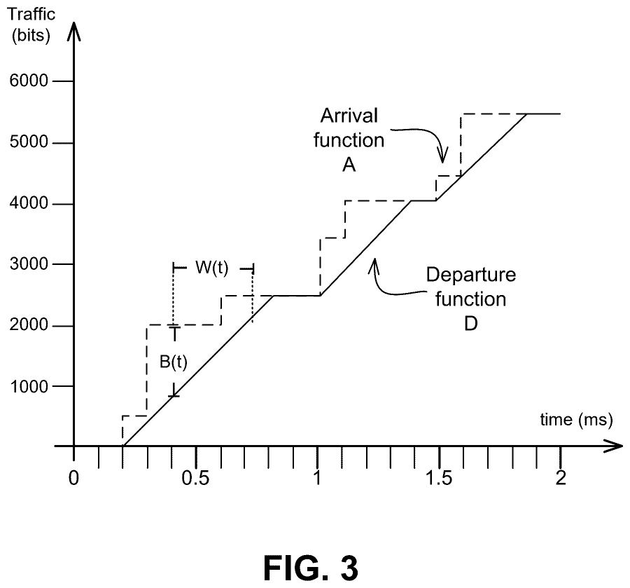

A traffic scheduling regulator (e.g., “S”) can be used (e.g., in uplink transmission), for example, to characterize traffic transmission rates at the WTRU. “S” may be used to determine the worst-case bounds on delay and backlog in the WTRU's buffer, for example, as illustrated in FIG. 2, where A may describe the cumulative arrival function of traffic for a given flow to the WTRU's buffer. D may describe the transmission departure function from the WTRU's buffer to a scheduled grant, for example, as illustrated in FIG. 3.

FIG. 2 illustrates an example a traffic scheduling regulator “S”. FIG. 3 illustrates an example UL traffic Arrival and Departure function at the WTRU buffer.

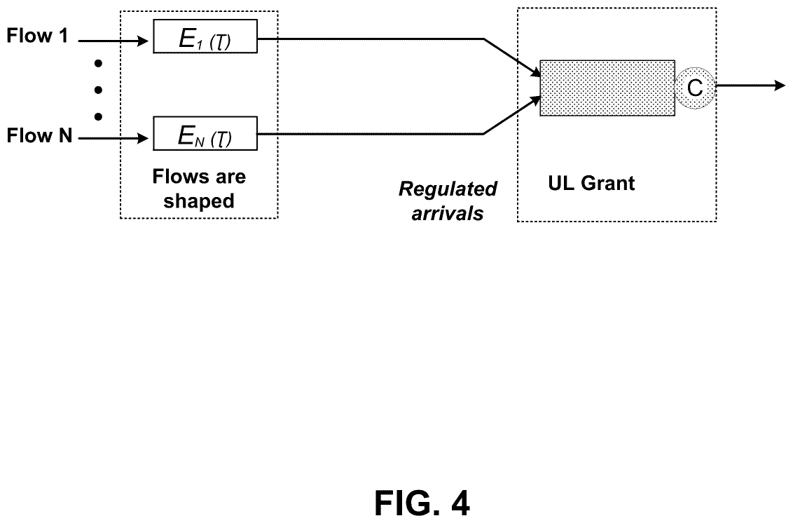

A (e.g., each) traffic flow competing for resources on a given uplink grant can be shaped by an envelope “E”, for example, such that E(t−s)>=A(s,t) (e.g., as illustrated in FIG. 4). A traffic shaper may include a scheduling implementation, for example, which may enforce that departing UL traffic complies to a given traffic envelope and/or which may buffer non-compliant traffic.

FIG. 4 illustrates an example prioritization between N data flows competing for UL resources on a grant of size C.

Traffic may be shaped for a given flow. Traffic may be shaped for a given flow, for example, because an operator may want to enforce that traffic from and to a given data flow complies to the subscribed data rate. Traffic may be shaped for a given flow, for example, because video streaming over a cellular network may use (e.g., require) matching the rate of video streams to the available capacity of the radio frequency (RF) link.

This kind of regulation is referred to as traffic shaping or smoothing. Transmitted traffic can be classified as one or more of the following: shaped/compliant traffic; non-shaped traffic; etc. Shaped/compliant traffic may include traffic that satisfies a given traffic specification (e.g., traffic served in with the bounds of the traffic departure envelope). Non-shaped traffic may include traffic allocated to a grant and/or traffic exceeding the traffic shaper (e.g., the water level in traffic shaping bucket). Such traffic (e.g., non-shaped traffic) may be considered lower or best-effort priority. Non-shaped traffic may be buffered, for example, if not transmitted.

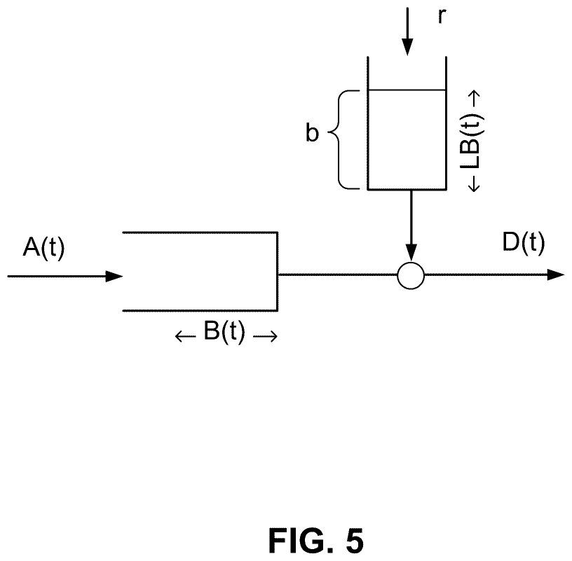

FIG. 5 illustrates an example leaky bucket traffic departure shaper. An example of a traffic shaping regulator for a given flow is the Leaky bucket algorithm (e.g., as illustrated in FIG. 5). For example, the bucket may be filled with fluid up to the indicated level (e.g., where LB(t) may indicate the filling level of the bucket at time t). A leaky bucket may enforce an envelope (e.g., of the form E(t)=b+r*t). In example, b may be the maximum burst size (e.g., useful for bursty traffic), and r may be the long-term traffic rate (e.g., set as the statistical average of the traffic transmission rate requirement). The bucket may be set (e.g., initially set) to LB(0)=b, for example, which may be referred to as a full bucket. The buffer may be filled with fluid at a rate r. Nothing may be added (e.g., addition to the bucket may be refrained from being performed), for example, if (e.g., when) the bucket is full. The content of the bucket LB(t) may corresponds to the maximum amount of traffic that can be transmitted at the time of TB construction (e.g., assuming sufficient space). For a (e.g., each) transmission of an SDU, the content of the leaky bucket may be reduced by the size of the SDU. The bucket may be empty, for example if (e.g., when LB(t)=0). Traffic may be refrained from being transmitted (e.g., no traffic can be transmitted), for example, if the bucket is empty. Traffic arrivals to an empty bucket may be stored in the buffer. Traffic in the buffer may be transmitted at the filling rate r.

A logical channel prioritization (LCP) (e.g., LCP algorithm) may be used for UL TB construction and. A network element (NE) may be an example of a leaky bucket implementation. The LCP “Bj” may be a leaky bucket (e.g., essentially a leaky bucket) that may enforce that traffic complies to a long-term rate (PBR) and a bucket size (PBR×BSD). The LCP leaky bucket may enforce an envelope of the form E(s)=b+PBR. S. For example, where b may be 0 and/or PBR may be the long-term traffic rate (e.g., set as the statistical average of the traffic transmission rate requirement). A LCP bucket may enforce an envelope of the form E(s)=PBR.

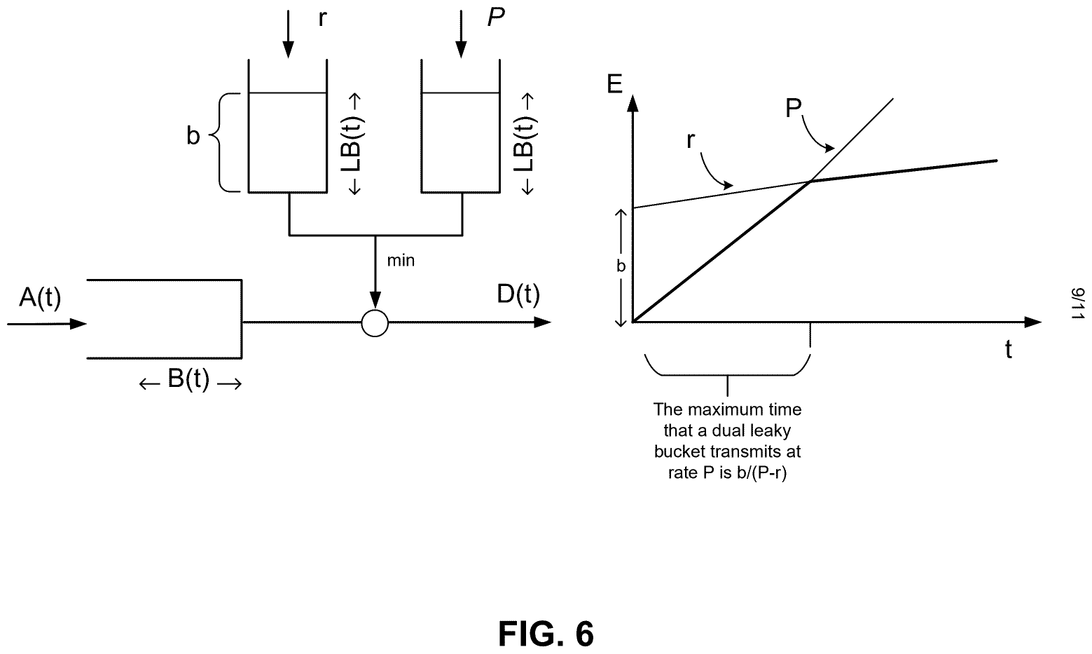

FIG. 6 illustrates an example dual leaky bucket traffic departure shaper. A variation of the leaky bucket may include a dual leaky bucket or a peak-rate constrained leaky bucket. This traffic regulator may enforce an envelope of the form E(t)=min {P t; b+r t}, for example, as illustrated in FIG. 6. A dual leaky bucket may regulate (e.g., provide the ability to regulate) the traffic rate on a short term (e.g., via parameters P and b) and/or the long term (e.g., via parameter r), for example, providing flexibility to handle complex arrival functions. In examples, r may be configured as average rate of the traffic arrival process (e.g., the long-term average traffic rate). In example, P>r may be the max data rate. The peak rate parameter may bound the maximum short term transmission rate at which traffic departs the traffic regulator. A dual leaky bucket for UL traffic shaping over a cellular network may be used and/or described herein.

The selection of a peak rate, P, may be determined. The selection of a peak rate P may be determined, for example, based on a function of the network resources. For example, the selection of the peak rate P may be determined if (e.g., when) network resources impose constraints on the maximum rate at which traffic can be processed or transmitted (e.g., maximum data burst volume (MDBV) within a period). The selection of a peak rate P may be determined based on a function of traffic (e.g., for a transmission of compressed/coded video data traffic). For example, a video encoder may use a fully transmitted video frame before the arrival of the next frame from the application (e.g., require that a video frame must be fully transmitted before the arrival of next frame from the application). The rate P may be determined (e.g., given) based on the ratio of the largest video frame (e.g., in bytes) multiplied by the frame rate (e.g., 50 frames per second). In examples, a gated transmission can be defined. A WTRU may proceed to transmit further PDUs in the set with index>x, for example, if PDU x within a PDU set succeeds. Further PDU transmissions (e.g., further new PDU transmissions) may be halted, for example, if PDU x doesn't succeed. In such case, P may satisfy the transmission of PDU x in a (e.g., one) grant.

An L2 data plan interface (e.g., new L2 data plane interface) may be used (e.g., needed).

The user plane interface (e.g., current user plane interface) may meet best effort data with a minimum and/or guaranteed bit rate requirements (e.g., not much beyond such requirement). An L2 data plane interface (e.g., new L2 data plane interface) can consider one or more of the following (e.g., requirements): computational efficiency; support of different data types; WTRU and network power consumption; scheduling, capacity, and/or congestion; application layer awareness; etc.

An L2 data plane interface may consider computational efficiency. L2 processing may scale (e.g., linearly scale) with packet rate. For example, as the packet rate increases, it can significantly boost processing demands and power consumption, for example, creating overhead challenges for both the network and the WTRU. Layering of L2 protocols may create a hierarchical structure (e.g., an overly hierarchical structure) leading to manufactured latencies and increased computational complexity.

An L2 data plane interface may consider QoS, latency, and/or reliability. An L2 interface may support a variable QoS requirement, low latency, and/or high reliability (e.g., including extreme applications, including XR, VR, AR, HRLLC, eURLLC). Retransmissions may be duplicated in multiple layers. Retransmissions at higher layers (e.g., RLC) may be too slow to meet latency sensitive applications (e.g., XR). Retransmissions may be rigid (e.g., retx data is exactly the same, same TB size, same carrier etc). QoS attributes can be assigned to a (e.g., each) data set/channel, including the KPIs (e.g., usual KPIs (e.g., Priority, PBR, PDB, PER, BLER), and additional KPIs (e.g., PDSB, dependencies to other sets, strict delay, energy consumption, complexity metrics)). An L2 interface may enable elastic QoE level varying (e.g., between the min data rate/GBR and max data rate), though QoS is met. QoE may meet (e.g., must meet) a minimum threshold (e.g., requirement). For example, the WTRU may start transmission of data with a given QoE level that is higher. As a WTRU moves out of coverage, experiences cell congestion, or when data rate drops, the WTRU may reduce the QoE level or reduce the number of data packet sets that are transmitted (e.g., if there are multiple/multi-modal streams, the WTRU may drop one stream that is not necessary to meet the min QoE level while still maintaining the QoS).

An L2 data plane interface may consider support of different data types: SRB and DRB data may be differentiated. Treatment of user plane (UP) data QoS may be controlled by QoS flow to DRB mapping. Packet treatment may be done semi-statically, for example, once mapped to a DRB. Applications (e.g., new applications; AI/ML, XR, sensing, volumetric video) may introduce data types (e.g., new data types), for example, within a QoS flow. A UP (e.g., NR UP) may refrain from providing (e.g., may not provide) differentiated treatment for more important/systematic packets (e.g., for a QoS flow). Data sets can be classified by type (e.g., control, data, sensory, AI/ML data). The L2 interface may support means to avoid unnecessary data transmission, and/or handling of QoS/QoE dependencies between different data types (e.g., UP, CP, system data) and/or dependencies b/w data of the same type.

An L2 data plane interface may consider WTRU and/or NW power consumption. The L2 protocol may enable both WTRU and NW power savings. DRBs may not be elastic, for example, in terms of resource allocation and mapping across cells and cell groups. The L2 interface may support means for WTRU reachability (e.g., timely WTRU reachability), WTRU processing chain power consumption, balancing NW and/or WTRU energy consumption, etc. A PDU may be able to transmit/receive in a more dynamic manner, for example, without rigid restrictions on DRB, carrier, or cell group.

An L2 data plane interface may consider scheduling, capacity, and/or congestion. Configured grants may be responsive to delay bounds (e.g., but may consume heavy overhead). Transmission on dynamic grants following SR/BSR can incur delays. LCP may be based on leaky bucket uplink traffic shaping. LCP may refrain from considering (e.g., may not consider) inter-packet associations, latency bounds, or congestion.

An L2 data plane interface may consider application layer awareness. A UP (e.g., NR UP) may refrain from providing (e.g., may not provide) differentiated treatment for more important packets (e.g., relevance may vary over time or over other control reception, e.g., within a bearer). Several applications may generate packets that have different importance. L2 protocols may not use (e.g., may not have evolved with) application layer transport protocols (e.g., new application layer transport protocols, e.g., QUIC developed for faster, more reliable, and more efficient data transfer). Awareness may include RAN awareness of application QoS and QoE metrics/data (e.g., events, important/relevant data) and the application being aware of RAN dynamic conditions (e.g., radio conditions, congestion, cell load etc). The application itself may adjust the rate of the packet set, and in such case the WTRU may not change the underlying QoE level (e.g., when the video rate is decreased by the application). This may mean that the WTRU may or may not be aware of what the application layer (e.g., no awareness in the first case, but awareness in the second way). Awareness may involves awareness of application flow dependencies and synchronization and other system data (e.g., sensory, ML, CP triggered events like handover etc).

Application-aware uplink resource allocation may be enabled, for example, that may enable considering flow dependencies, packet associations, congestion, and data types (e.g., new data types, e.g., sensory, data, control).

A TB (e.g., LTE/NR TB) construction algorithm may prioritize (e.g., be limited to prioritize) among different data types and flows (e.g., in context of more advanced applications).

Logical channel prioritization (LCP) (e.g., based on leaky bucket uplink traffic shaping) may work (e.g., efficiently work) for best effort type of traffic with minimum or guaranteed data rate requirements. LCP may refrain from considering (e.g., may not consider) one or more of the following: PDU burst size; inter-packet association(s); different data type(s) and/or dependencies; latency bounds; congestion; packet priority within a data flow; prioritization between transmission of data (e.g., new data) and reconstructed retransmitted data; etc.

LCP may consider PDU burst sizes. UL data burst transmission without delay may be enabled. LCP may be associated with filling a traffic departure shaping bucket (Bj) at a rate (PBR). LCP can transmit (e.g., guarantee transmitting) such packet (e.g., only) a time (e.g., PBR x PDU size) later, for example, if (e.g., when) the bucket is empty and a different (e.g., new) burst arrives (e.g., a video frame or a deterministic PDU size for the traffic type). PBR may be configured (e.g., typically configured) as the long term average rate of the traffic (e.g., limit of A(0,T)/T as T goes to infinity). The PBR may (e.g., must) be set as the burst size/burst duration, for example, to transmit (e.g., efficiently transmit) a burst (e.g., instantaneously). Such rate can be prohibitive (e.g., too prohibitive) and/or capacity consuming, for example, causing starvation to other data flows competing for the grant.

LCP may consider inter-packet associations. Handling differentiation among packets of the same flow (e.g., if/when allocating UL resources) may be enabled. A set of PDUs (e.g., frames from a given video service, PDUs from an AR/XR PDU set, PDUs from a set of error coded PDU set, etc.) may be modelled as a given QoS flow mapped to a given DRB, for example, where the DRB is associated with a given LCH. Such LCH may have a (e.g., one) global priority from an LCP perspective. Certain packets/PDUs from a PDU set may not be differentiated (e.g., a system video frame). SDUs (e.g., all SDUs) belonging to the same LCH may have the same priority.

LCP may consider different data types and dependencies. Handling of data dependencies (e.g., if/when allocating UL resources to competing flows) may be enabled. For example, whether data is associated with CP, UP, sensory, or AI/ML, data dependencies may be handled. SRB and DRB data may be differentiated. Treatment of UP data QoS may be controlled by a QoS flow to DRB mapping. Packet treatment may be done semi-statically, for example, once mapped to a DRB. Applications (e.g., new applications, e.g., AI/ML, XR, sensing, volumetric video) may introduce data types (e.g., new data types), for example, within a QoS flow. UP (e.g., NR UP) may refrain from providing (e.g., may not provide) differentiated treatment for more important/systematic packets (e.g., for a QoS flow). There may be possibility that there is system data be assumed in addition to control plane and user plane (e.g., service data) but also that there may be dependencies to manage between data of the same service, between UP data (e.g., an XR service that has AR, or a subset of the data such as AR objects, metadata for scene description and/or updates thereof) and system data (e.g., sensing of real objects+position to help anchoring the AR objects coherently with the real world), and/or with CP data (e.g., in case of mobility triggers that initiates from sensing activity that is associated to mobility, for example, events and measurements that aim to detect blockage). In examples, dependency within a packet data set may include an FEC encoded set, for example, where X our of Y encoded PDUs may be decoded (e.g., may be necessary to decode X out of Y encoded PDUs) to decode the overall data set.

LCP may consider latency bounds. Delay-aware UL resource allocation (e.g., while keeping fairness to other competing flows) may be supported.

Allocation of buffered UL data may be done based on priority-first and prioritized bit rates. In cases of congestion, some data flows may face starvation, for example, if (e.g., when) priority flows (e.g., high priority flows) have much higher PBRs. This can cause lower priority data flows to miss their delay bounds.

LCP may consider congestion. Starvation of UL data flows when allocating resources may be avoided. Congestion within the WTRU when multiple flows are competing for UL resources may be handled. There can be congestion from WTRU perspective, for example, where higher priority PDUs are transmitted, and lower priority ones are not at all. In XR examples, such packets may be discarded (e.g., eventually discarded), for example, if (e.g., when) higher importance packets are available for transmission. It may not be favorable to discard data, for example, (e.g., unless needed) to avoid data loss. During such congestion conditions, some lower priority data flows can face starvation.

LCP may consider packet priority within a data flow. Higher priority packets within a given data flow with semi-statically configured priority for UL resource allocation may be handled. LCP may succeed (e.g., be good) at meeting data rate requirements (e.g., minimum data rate requirements). Packets may be fed to the LCP algorithm in a FIFO fashion (e.g., by order of SN). Packets (e.g., all packets) may be treated equally, for example, within a given data set mapped to a LCH. Treating packets equally may not be favorable for some applications (e.g., volumetric video where some frames provide means to producing an image of the overall picture, higher layer error encoded PDU sets with some carrying more systematic/important bits for decoding the overall set, or a gated transmission where if a given PDU x within a set is not transmitted, follow up PDUs with index>x are useless to the application etc.).

UL traffic shaping may include per packet treatment for UL traffic shaping.

A WTRU may be configured per data flow (e.g., LCH) with multiple sets/policies of UL traffic shaping parameters (e.g., a set of traffic shaping parameters). The set of traffic shaping parameters may include a rate (r), a burst size (b), a bucket size (BSD), a number of buckets, an envelope, and/or the like (e.g., the set of traffic shaping parameters may include (r, b, P, BSD)). The WTRU may determine the applicable set of parameters to update a traffic shaping bucket for a given flow, for example, based on a characteristic associated with the data (e.g., the type of data (e.g., control, data, sensory, or ML)). The WTRU may determine the applicable set of parameters to update a traffic shaping bucket for a given flow, for example, based on the PDU priority within the flow (e.g., gating PDU, video frame meta data, or video defining frame).

Conditional selection may be performed. Conditional selection of envelope/bucket filling parameters (e.g., r, b, P, BSD) may be performed. Conditional selection of an LCP policy may be performed. Conditional selection of a QoS classifier may be performed.

The WTRU may be receive configuration information indicating (e.g., be configured (e.g., semi-statically configured) with) multiple sets (e.g., a first set and a second set) of (e.g., UL) traffic shaping parameters (r, b, P, BSD) and policies. The WTRU may receive an uplink grant for transmission. The sets of traffic shaping parameters may be associated with QoS classifiers. For example, a first set of traffic shaping parameters may be associated with a first QoS classifier. A second set of traffic shaping parameters may be associated with a second QoS classifier.

An LCP policy may be associated with one or more of the following: a shortest remaining time first, priority based, an algorithm (e.g., preconfigured or existing algorithm), shaping disabled, etc.

Such attributes can be included under a treatment profile (e.g., QoS/QoE treatment profile) associated with the data flow (e.g., LCH).

The WTRU may determine a QoS classifier, a set of parameters, and/or a shaping policy (e.g., the applicable set of parameters and/or a shaping policy), for example, based on a condition and/or the UL traffic shaping classifier for the buffered packets (e.g., as described herein). For example, the WTRU may determine a QoS classifier, a set of parameters and/or a shaping policy based on one or more of the following (e.g., based on one or more of the following characteristics): a packet type (e.g., inclusion of a systematic, high priority, or a gating packet); an interaction of with system/sensory data; a transport layer protocol (e.g., TCP ACK, out of order packets, etc.); a reception of an indication from higher layers (e.g., from an application), for example, indicating that such packet may be prioritized (e.g., needs to be prioritized) ahead of other buffered packets in the queue for such data flow; a function of the UL traffic shaping classifier (e.g., as described herein), QoE level of the service, the QoS treatment profile, or an indication from the application; etc.

The WTRU may determine a set of parameters and/or a shaping policy for gated/periodic traffic. A first set of parameters or first QoS classifier associated with the first set of parameters may be determined (e.g., r may be increased and/or the bucket may be reinitialized with a b value) to meet scheduling of such PDU (e.g., select a set of parameters associated with such higher QoE transmission), for example, if a PDU x arrives every y ms, and PDU x is systematic or enables a gated transmission. A second set of parameters may be determined, for example, for other PDUs. The second set of parameters may use a lower value for b and/or r.

The WTRU may determine a QoS classifier, a set of parameters, and/or a shaping policy for video traffic with systematic frames. In examples, video applications (e.g., some video applications) may not benefit from transmission of frames following a systematic frame (e.g., because the picture may not be complete without it). For example, a systematic frame may be (e.g., should be) transmitted (e.g., fully transmitted) before transmission of subsequent frames. The WTRU may to increase r and/or reinitialize the bucket with a b value to meet scheduling of such PDU (e.g., select a set of parameters associated with such higher QoE transmission), for example, for systematic frames. For other PDUs, the WTRU may use a lower value for b and/or r.

The WTRU may be configured per data flow (e.g., LCH) with multiple sets/policies of UL traffic shaping parameters (e.g., sets of traffic shaping parameters). The set of traffic shaping parameters may include traffic shaping parameters (e.g., r, b, P, BSD, etc.). The WTRU may determine a set of traffic shaping parameters (e.g., the applicable set of parameters) to update a traffic shaping bucket for a given flow (e.g., update a traffic shaping bucket for a given data packet in the flow), for example, as a function of the UL shaping policy signaled or configured for the grant or grant type.

In examples, the WTRU may receive configuration information indicating (e.g., be configured, be configured semi-statically with) multiple sets of UL traffic shaping parameters (e.g., r, b, P, BSD) and/or policies. Each set of traffic shaping parameters may be associated with a respective QoS classifier.

The WTRU may determine a QoS classifier associated with a set of traffic shaping parameters per data packet for a data flow. For example, the WTRU may receive configuration information comprising a first set of traffic shaping parameters and a second set of traffic shaping parameters. The first set of traffic shaping parameters may be associated with a first QoS classifier. The second set of traffic shaping parameters may be associated with a second QoS classifier. The WTRU may receive an uplink grant. The WTRU may determine a QoS classifier (e.g., based on a condition, characteristic, and/or the like associated with a data packet). The WTRU may determine a set of traffic shaping parameters associated with the determined QoS classifier. The WTRU may multiplex data associated with the data flow on the uplink grant, for example, based on determined QoS classifier and/or associated set of traffic shaping parameters. The WTRU may send the multiplexed data, for example, using the uplink grant.

The WTRU may determine a QoS classifier associated with a set of traffic shaping parameters per data packet for a data flow or determine a set of traffic shaping parameters per data packet for a data flow. For example, the WTRU may receive configuration information comprising a first set of traffic shaping parameters and a second set of traffic shaping parameters. The WTRU may receive an uplink grant for transmission. The WTRU may determine a third set of traffic shaping parameters for a first data packet in the data flow. The WTRU may determine a fourth set of traffic shaping parameters for a second data packet in the data flow. The third set of traffic shaping parameters and the fourth set of traffic shaping parameters may be the first set of traffic shaping parameters or the second set of traffic shaping parameters. The third set of traffic shaping parameters may be different from the fourth set of traffic shaping parameters. The WTRU may multiplex data associated with the data flow on the uplink grant, for example, based on the third set of traffic shaping parameters and the fourth set of traffic shaping parameters.

Dynamic UL traffic shaping may be enabled by NW control. For example, the WTRU may receive signaling indicating the applicable UL traffic envelope and/or LCP policy. The signal may be associated with a grant (e.g., the WTRU may be signaled for a grant dynamically), for example, in a DCI for a shaping policy or a grant. The WTRU may be semi-statically configured for a grant type (e.g., configured grant, a given CG index, a dynamic grant with a specific PHY attribute or a PHY signaling value associated with the grant). The signaling may be associated with a duration (e.g., period of time), for example, that may be semi-statically configured. The signaling may be associated with a subset of signaled data flows. In examples, a policy (e.g., LCP policy) may include one or more of the following: r, b, P, a bucket size, a number of applicable buckets, an algorithm; etc.

UL traffic shaping envelope may be controlled (e.g., dynamically controlled), for example, by NW control. The WTRU may receive signaling (e.g., from the NW) indicating the applicable UL traffic envelope and/or a change (e.g., temporary change) of traffic shaping parameters (e.g., change from a first set of traffic shaping parameters to a second set of traffic shaping parameters). The signaling may include one or more of the following: r, b, P, a bucket size, a number of applicable buckets, an envelope, etc. For example, dynamic signaling (e.g., DCI) can be issued to control the configuration (e.g., active configuration) of the shaping parameters for a given shaper (e.g., for the WTRU overall or for a data flow).

The WTRU may determine an exception for UL traffic shaping (e.g., the WTRU may exceptionally violate (e.g., ignore) UL traffic shaping. For example, an determining an exception for UL traffic shaping may be associated with the WTRU allocating resources beyond the bucket level. The WTRU may determine an exception for UL traffic shaping, for example, based one or more of the following (e.g., as a function of one or more of the following): inclusion of a systematic packet, inclusion of a high priority packet, inclusion of a gating packet, etc. For such packets, the WTRU may prioritize them ahead of other packets in the data flow buffer ahead of it.

Exceptions from traffic shaping may be (e.g., may be determined based on) a function of UL traffic shaping classifier for the packet (e.g., as described herein). For example, systematic/high importance/or gating PDUs can be exempted from traffic shapers. For example, PDU x (e.g., a video frame that may be (e.g., must be) transmitted (e.g., fully transmitted) before the arrival of a next frame from the application) may be considered as non-shaped (e.g., bypasses the shaper (e.g., PBR can be temporarily considered as infinity)). The WTRU may allocate UL resources within a grant beyond (e.g., or regardless of) the UL traffic shaping bucket level (e.g., Bj) to a given data flow (e.g., the WTRU may determine an exception to traffic shaping), for example, based on one or more of the following: a packet type (e.g., inclusion of a systematic, high priority, or a gating packet); an interaction of with system/sensory data; a transport layer protocol (e.g., TCP ACK, out of order packets, etc.); a reception of an indication from higher layers (e.g., from application) indicating that such packet needs to be prioritized ahead of other buffered packets in the queue for such data flow; etc.

Exceptions from traffic shaping may be (e.g., may be determined based on) defined rules and/or durations (e.g., via timers). The rules and/or durations may ensure that there are no capacity violations (e.g., NW configures PDU type for such exception, and/or a timer where the exception can be done once while timer is running).

Exceptions from traffic shaping may be associated with a WTRU decrementing the shaping bit level (e.g., Bj) by the size of allocated bits (e.g., which may imply a negative level value).

An exception for a filling order of SDUs from a given LCH (e.g., rather than a first in first out (FIFO) policy) may be associated with SDUs (e.g., some SDUs) being enabled to go ahead, for example, as a function of delay/importance/SDU, data type, or an RLC transmission (e.g., new transmission) compared to an RLC retransmission.

For a given data flow, the WTRU may prioritize the inclusion of buffered data ahead of the head of the buffered FIFO queue (e.g., as a function of UL traffic shaping classifier for the packets).

In a congestion context, there can be some per WTRU shaping (e.g., overall per WTRU shaping), where some allocated resources to some flows may be dropped and associated data may be discarded/not prioritized (e.g., remains buffered).

Details associated with gated data sets or periodic data sets may be described herein.

A gated traffic data flow may include (e.g., be defined as) a data set, for example, where there is a subset of gating PDUs and non-gated PDUs. Transmission of a gating PDU may enable the transmission of non-gating PDUs. For example, PDU x may arrive every y ms and PDU x may be a gating systematic PDU that enables a gated transmission. PDU x+1 may be refrained from being transmitted (e.g., not be transmitted), for example, if PDU x is not transmitted or if PDU x is not deemed to be transmitted successfully (e.g., acknowledged). In examples, PDUs (e.g., all PDUs) between t and t+y may be refrained from being transmitted (e.g., not transmitted), for example, unless PDU x is transmitted or transmitted successfully if PDU x arrives/or is transmitted at time instance t.

Video traffic may include systematic frames.

Video applications (e.g., some video applications) may not benefit from transmission of frames following a systematic frame, for example, because the picture may not be complete without it (e.g., systematic frame may be (e.g., should be) transmitted (e.g., fully transmitted) before transmission of subsequent frames). For such systematic frames, the WTRU may determine (e.g., change) traffic shaping parameters (e.g., increase (r) or reinitialize the bucket with a b value), for example, to meet scheduling of such PDU (e.g., select a set of parameters associated with such higher QoE transmission). The WTRU may use a lower value for b and/or r for other PDUs.

A property of scheduling information (e.g., an uplink grant or a downlink assignment) may include one or more of the following: a frequency allocation; an aspect of time allocation (e.g., time instance or/and a time duration); a priority; a modulation and coding scheme; a transport block size; a number of spatial layers; a number of transport blocks to be carried; a TCI state or SRI; a number of repetitions; whether the grant is a configured grant type 1 (e.g., WTRU may use (e.g., immediately use) the configured UL resources after receiving the configuration information), type 2 (e.g., WTRU may wait for an indication (e.g., until an explicit MAC CE indication) before using the configured UL resources), or a dynamic grant; etc.

An indication (e.g., by DCI) may include one or more of the following: an explicit indication by a DCI field or by RNTI used to mask CRC of the PDCCH; an implicit indication by a property, for example, such as DCI format, DCI size, Coreset or search space, aggregation level, identity of first control channel resource (e.g., index of first CCE) for a DCI (e.g., where the mapping between the property and the value may be signaled (e.g., by RRC or MAC)); an explicit indication by a DL MAC CE; etc.

Channel conditions may include a condition (e.g., any conditions) relating to the state of the radio/channel, for example, which may be determined by the WTRU from one or more of the following: a WTRU measurement (e.g., L1/SINR/RSRP, CQI/MCS, channel occupancy, RSSI, power headroom, exposure headroom), L3/mobility-based measurements (e.g. RSRP, RSRQ, s-measure), an RLM state, and/or channel availability in unlicensed spectrum (e.g. whether the channel is occupied based on determination of an LBT procedure or whether the channel is deemed to have experienced a consistent LBT failure), etc.

Allocating bits to a grant or serving a data flow may include (e.g., refer to) allocation of bits and/or UL resource within a given grant when constructing a transport block for that grant. It may be assumed that the WTRU may transmit a bit on the associated uplink grant (e.g., a PUSCH transmission), for a (e.g., each) bit allocated to a grant.

The terms ‘a’ and ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ may be to be interpreted as ‘may, for example’. A symbol ‘/’ (e.g., forward slash) may be used herein to represent ‘and/or’, where for example, ‘A/B’ may imply ‘A and/or B’.

Details associated with UL traffic shaping envelopes may be described herein. A UL traffic shaper may include a scheduling implementation, for example, which may enforce that departing UL traffic complies to a given traffic envelope. The UL traffic shaper may buffer, deprioritize, and/or discard non-compliant traffic, for example, in a round (e.g., at least in one round) of resource allocation of bits to a grant. A traffic shaper may include one or more of the following: a leaky bucket and dual leaky bucket, a max burst size shaper (E=burst size); a deterministic shaper for periodic traffic (e.g., E=A(period)/period); a time variant shaper (e.g., enabled by NW signaling to control shaping parameters), for example, a leaky bucket with dynamically signaled shaping parameters (e.g., r, b, P, BSD); a shortest remaining time first (e.g., shortest remaining time first policy), among buffered data units applicable for the grant; a highest static priority first (e.g. highest QoS class) policy, for example, among buffered data units applicable for the grant; a first in first out policy, for example, among buffered data units applicable for the grant; a no shaping (e.g., a no shaping policy), for example, wherein a data flow is not limited or limited to the size of the grant (e.g., only to the size of the grant).

A traffic shaper may include a leaky bucket and/or a dual leaky bucket. The leaky bucket and/or dual leaky bucket may be used with shaping exceptions, for example, if (e.g., when) some conditions are met. Multiple shapers may be used where one or more is applicable for a given time/grant. The minimum shaping water level of the multiple shapers may be taken as the overall limit, for example, if (e.g., when) more than one is applicable.

The WTRU may maintain a UL traffic shaping bucket (e.g., Bj) for a (e.g., each) data flow, a (e.g., each) QoS class, a (e.g., each) UL traffic shaping envelope, and/or per WTRU/MAC entity (e.g., for data flows (e.g., all data flows)). The WTRU may decrease the bucket by the value of the served buffered bits, for example, if (e.g., when) serving buffered data from a given flow and allocating UL resources in the grant to it (e.g., bit allocation in the TB). The water level in the bucket (e.g., Bj) may be negative at some time, for example, for some exceptions (e.g., if/when using a non-default envelope or if/when serving data from data units from a given QoS class). The WTRU may (e.g., for a given grant) serve buffered data to the grant from a (e.g., each) flow up to the water shaping level (e.g., Bj), for example, in (e.g., at least in) a first allocation step/round. In a second round(s), the WTRU may allocate resources (e.g., remaining resources) in the grant, for example, according the same envelope, a different envelope, or without shaping at all. The water level (Bj) may be decreased in the first and/or the second round(s) of resource allocation.

For a given data flow for which the WTRU maintains a shaping bucket (e.g., if the WTRU changes the shaping envelope for a subset of data units), the WTRU may update the bucket as described herein.

For example, the WTRU may update the water level. The water level may be updated as (Bj)=Bj+the fill rate of the applicable envelope “r” multiplied by time since the bucket was last updated. The WTRU may be configured or preconfigured with a bucket water level (Bj) update period. The WTRU may update the value after such update period elapses (e.g., once every such period). For a given bucket, the WTRU may update the water level according to the non-default shaping rate (e.g., applicable non-default shaping rate) “r” (e.g., where Bj+=r′ times the time since the last update to Bj or an update period configured for the shaping envelope), for example, if the non-default shaping is applied (e.g., as described herein) for a given data unit or a grant.

For example, the WTRU may fill the bucket with the value “b” of the applicable envelope.

For example, the WTRU may assume an updated bucket size of (BSD multiplied by r) while the applicable envelope is used for a given data unit.

The NW may have knowledge of the shaping parameters/envelope. The WTRU may notify the serving cell (e.g., part of assistance information or via a MAC CE), for example, if the WTRU changes (e.g., autonomously changes) a shaping parameter (e.g., any shaping parameters).

The WTRU may be configured with a UL shaping envelope (e.g., overall UL shaping envelope), for example, which the WTRU may use to limit the amount of data allocated to UL transmissions across buffered data flows (e.g., all buffered data flows). Such envelope may be used conditionally (e.g., only conditionally), for example, during a duration (e.g., while a timer is running), based on reception of an indication from the network (e.g., if configured), based on determining congestion at the WTRU or the serving cell, or based on transitioning to an energy saving state.

The WTRU may reinitialize and/or set the water level in the bucket “Bj” to a configured value b′ of the different envelope (e.g., newly applied envelope) or according to the associated fill rate r′ multiplied by the update period, for example, if (e.g., when) the WTRU maintains a single shaping bucket for a data flow or for the WTRU, and/or if the shaping envelope changes for a given data unit, grant, TB, or period. The WTRU may decrease the value of Bj by the amount of non-shaped data (e.g., in addition to the shaped data) and/or increase the value of Bj by that amount prior to multiplexing data for the grant, for example, if (e.g., when) the WTRU applies an exception from shaping (e.g., as described herein).

Details associated with a RAN data plane architecture may be provided herein.

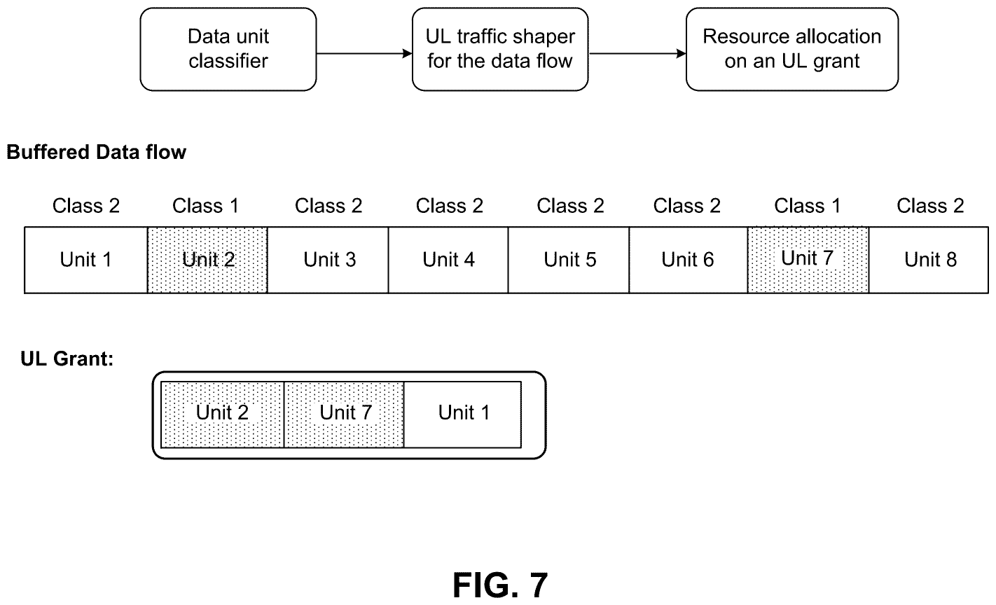

FIG. 7 illustrates an example data plane architecture framework. As shown in FIG. 7, an application may provide one or more IP flows for transmission over a medium. A (e.g., each) IP flow may go through a transport layer protocol (e.g., TCP/IP, QUIC, RTP, MOC, etc.). A (e.g., each) IP flow (e.g., a PDU session) may go through a RAN core network, for example, which may maps it to a RAN data flow or a RAN data set. The core network may attach (e.g., some) QoS requirements, a QoS metric, a range of QoE metrics, and/or the like, for example, for a (e.g., each) RAN data flow.

A RAN data flow may represent a logical association between data packets and/or units, e.g., originating from the same IP flow. Such association may be based on such data units being associated to the same IP flow, application flow, or having the same association packet marked either by the core network or the application.

A RAN data flow (e.g., some RAN data flows) may not originate from a user application. The RAN data flow (e.g., some RAN data flows) may originate from a control plane (e.g., control data and RAN signaling and configurations), an intelligence plane (e.g., data collected from AI/ML services), a computing plan (e.g., used for native computing for computing services), a system plane (e.g., data originating within the RAN, e.g., due to sensing or positioning services), and/or a security plane.

The WTRU may assign a QoS class to a (e.g., each) data unit within a RAN data flow for the purpose of characterization of how data should be transmitted. A data protocol plane may contain a data unit classification function for QoS/QoE marking throughout the protocol chain. The QoS/QoE class can be determined in such layer according to a rule (e.g., one or more configured or predefined rule). Such QoS class can be used in various layers within the data plan protocol chain, for example, for achieving a certain QoS requirement or a QoE level. A QoS class can indicated part of a protocol layer header. A (e.g., each) QoS/QoE class may be associated with a QoS/QoE treatment profile in the RAN, for example, which may be configured semi-statically. A (e.g., each) QoS treatment profile may include a parameter (e.g., a number of parameters) to control the RAN treatment of the data transmission/reception. A (e.g., each) QoS treatment profile may include a number of metrics to achieve the QoE level for a given layer in the protocol chain. A (e.g., each) QoS class or QoS treatment profile may be associated and/or configured with one or more of the following: a priority index, an importance level, a delay bound, a reliability level, a guaranteed bit rate, a maximum bit rate, and/or a maximum packet loss rate.

Packets within a data flow may be classified, for example, based on conditions and rules.

The WTRU may classify (e.g., use a procedure to classify) UL data units (e.g., packets within a data flow, SDUs, PDUs within a PDU set) on a dynamic basis, for example, where a data unit can be assigned with a QoS Class (e.g., if it meets one or more conditions).

The WTRU may assign a QoS class value (e.g., certain QoS class value) to a (e.g., given) data unit (e.g., which may or may not be the default QoS class), for example, if (e.g., once) a condition for QoS classification is met. The WTRU may receive configuration information indicating (e.g., be configured with) a default QoS class, for example, which may be associated with the data flow (e.g., preconfigured semi-statically for the whole data flow). The WTRU may classify a data unit from such flow with the configured default QoS class for the data flow, for example, if no special classification conditions are met. The WTRU may be configured or predefined with one or more non-default QoS class(es), for example, where there is a mapping between a given QoS class and a condition for QoS classification. The WTRU may associate the data unit with the non-default QoS class (e.g., once the condition is met).

A condition for QoS classification may include one or more of the following.

A condition for QoS classification may be associated with a packet priority. A condition for QoS classification may be associated with the packet priority, for example, based on the (e.g., possibility of) transmission/inclusion of buffered data from a subset of PDUs within a PDU set, for example, where such PDUs can be configured or predetermined to be of higher priority, a lower delay bound, or high QoS treatment profile compared to other PDUs within the set. The WTRU may associate data unit with a given QoS class (e.g., first QoS class), for example, if the data unit is of higher priority (e.g., higher than a threshold). The WTRU may associate data unit with another QoS class (e.g., second QoS class), for example, if the data unit is of lower priority (e.g., below a threshold).

A condition for QoS classification may be associated with a packet importance. A condition for QoS classification may be associated with packet importance, for example, based on the (e.g., possibility of) transmission/inclusion of buffered data from a subset of PDUs within a PDU set. Such PDUs can be configured or predetermined to be of higher importance compared to other PDUs within the set. Importance may be associated with a value obtained from an indication, for example, from the core network packet profile, the application interface, or from the service characteristics (e.g., the period of the packet or the type of packet associated with it). The WTRU may associate data unit with a given QoS class (e.g., first QoS class), for example, if the data unit is of higher importance (e.g., higher than a threshold). The WTRU may associate data unit with another QoS class (e.g., second QoS class), for example, if the data unit is of lower importance (e.g., lower than a threshold).

A condition for QoS classification may be associated with a packet delay budget. A condition for QoS classification may be associated with a packet delay budget, for example, based on the (e.g., possibility of) transmission/inclusion of buffered data from a subset of PDUs within a PDU set (e.g., where the remaining time until the delay budget for the PDU or the underlying application is less than a threshold). The WTRU may associate the data unit with a given QoS class, for example, if the delay budget is less than a threshold.

A condition for QoS classification may be associated with the data type. A condition can be met as a function of inclusion of data from a given type, e.g., AI/ML, XR, sensing, volumetric video. For example, the WTRU may associate data unit with a given QoS class (e.g., first QoS class), e.g., for a data unit containing AL/ML data. The WTRU may associate data unit with another QoS class (e.g., second QoS class), for example, for a data unit containing sensing data.

A condition for QoS classification may be associated with reception of an indication from the application or the RAN-application interface (API). The application may indicate that for a data unit (e.g., given data unit), a differentiated QoS class may be associated. The indication may provide a given QoS class or an identifier associated with it. The WTRU may be configured with a given non-default QoS class to apply to a data unit, for example, if (e.g., once) an indication/flag is received from the API for such data unit. The WTRU may associate a different (e.g. non default) QoS class to the data unit, for example, based on reception of an indication from higher layers (e.g., from the application) indicating that such packet may be (e.g., needs to be) prioritized ahead of other buffered packets in the queue for such data flow.

A condition for QoS classification may be associated with a reception of an indication from the network overriding the configured default QoS class for one or more data flows. The indication may include a given QoS class to apply (e.g., possibly for a period of time). Such indication may be determined as a function of a property of the scheduling information (e.g., in the DCI) or an indication by DCI.

A condition for QoS classification may be associated with a reception of an indication for a given grant. A DCI may signal a given QoS class. The DCI may indicate that for such QoS class, data associated with such class (e.g., only data associated with such class) may be multiplexed. The WTRU may (e.g., alternatively) multiplex data (e.g., multiplex data regularly) on the grant (e.g., using the grant). The WTRU may treat the TB (e.g., whole TB) as data with the signaled QoS class (e.g., in lower layers). Such indication may be determined as a function of a property of the scheduling information (e.g., in the DCI) or an indication by DCI.

A condition for QoS classification may be associated with data from a gating data set. The WTRU may associate a given non-default QoS class to a gating data unit.

A condition for QoS classification may be associated with a function of dependent data or data set. A non-default QoS class (e.g. prioritized QoS class) may be assigned, for example, for a data unit that other units depend on (e.g., an FEC source packet, a video defining frame (e.g., I frame, a gating data unit, etc.)). A different QoS class may be assigned (e.g., a default QoS class associated with the flow), for example, for dependent, duplicated, or redundant data units.

A condition for QoS classification may be associated with a function of a systematic PDU within a set. A condition for QoS classification may be associated with a transmission/inclusion (e.g., possibility of transmission/inclusion) of buffered data of a systematic frame/data unit within a data flow (e.g., source data units that are encoded, systematic video frames, etc.).

A condition for QoS classification may be associated with satisfying one or more control plane event(s). A condition for QoS classification may be associated with satisfying one or more mobility event conditions. A condition for QoS classification may be associated with satisfying a conditional handover condition to one or more handover candidates. The WTRU may associate a different QoS class with a data unit (e.g., possibly for a period of time associated with the CP event), for example, based on satisfying a mobility condition, an RLM condition, a beam failure condition, or an RLF condition.

A condition for QoS classification may be associated with sensing an object or determining an outcome from a sensing or positioning procedure. For example, sending data may be configured or pre-associated with a given QoS class. The WTRU may select a certain QoS class (e.g., non default or configured QoS class), for example, based on detection of an object as a function of sensing or a spatial computing service as a outcome of sensing.

A condition for QoS classification may be associated with dropping or adding one or more data flows. The WTRU may change the QoS class associated with the remaining data flow or dependent data flow, for example, based on adding or dropping or more service or a data flow (e.g., from a multi-modal service or session).

A condition for QoS classification may be associated with synchronization between data flows. The WTRU may associate a (e.g., one) QoS class (e.g., first QoS class) to (e.g., for) data unit(s), for example, if (e.g., when) a dependent data flow is synchronized), for example, if synchronization between data flows is configured or indicated from the application or the core network. The WTRU may associate a (e.g., another) QoS class (e.g., second QoS class), if (e.g., when) the data flow is not synchronized or within a period of miss-synchronization (e.g., a remaining synch time is larger or lower than a threshold), for example, if synchronization between data flows is configured or indicated from the application or the core network. The WTRU may use the same QoS class for data units of both data flows, for example, if a common identifier is used (e.g., signaled from the application or the core network) to associate the two flows. The WTRU may revert to the default QoS classes configured for each data flow individually, for example, once dissociated.

A condition for QoS classification may be associated with dropping or adding one or more dependent data types. The WTRU may be configured to obtain (e.g., need) X out of Y data units to decode an overall packet (e.g., an FEC encoded packet, a source video frame etc.). The WTRU may select a given QoS class (e.g., first QoS class) if (e.g., when) X out Y data units have been successfully decoded. The WTRU may associate a different QoS class (e.g., second QoS class) if (e.g., when) X out of Y data units have not been successfully decoded and/or if X′ out of Y units have been received, and/or if X″ units have been not acknowledged but received.

A condition for QoS classification may be associated with satisfying one or more event from the transport layer protocol (e.g., generating TCP ACK, transmission of an out of order packet within a transport protocol session/connection, reading a specific value from the header of the transport layer protocol for a given packet). The WTRU may associate the associated data unit of the related RAN data flow with a given QoS class, for example, if (e.g., once) such condition is met. The WTRU may (e.g., be able to) determine or more property of the transport layer protocol, for example, from a relay on top of the RAN protocol stack (e.g., which may be used to de-cypher and decrypt the transport layer header and/or content if encrypted).

A condition for QoS classification may be associated with measuring a channel condition below or above a given threshold. A condition for QoS classification may be associated with measuring a change in the channel conditions below or above a given threshold. The WTRU may associate a data unit with a given QoS class, for example, if (e.g., once) such condition is met.

A condition for QoS classification may be associated with a function of whether the data unit is transmitted initially or retransmitted. A condition for QoS classification may be associated with a function of the retransmission number.

A condition for QoS classification may be associated with a function of the energy saving state of the network (e.g., which may be indicated to the WTRU). A condition for QoS classification may be associated with the power saving state of the WTRU (e.g., whether DRX is used).

A condition for QoS classification may be associated with a transmission or determination of successful transmission of a dependent data type or a dependent data unit (e.g., possibly only from the same data flow or from a different data flow). A WTRU may determine QoS class B for data unit y, for example, if a data unit x is successfully transmitted. The WTRU may determine QoS class A for data unit y, for example, if a data unit x is not successfully transmitted. For example, y may be x+1. Data unit y can be a UL or a DL data unit.

A condition for QoS classification may include a reception or successful reception of a dependent data unit on the downlink (e.g., on a PDSCH), for example, from (e.g., only from) an associated data flow by configuration. The WTRU may determine QoS class B for UL data unit y, for example, if a DL data unit x is successfully received. The WTRU may determine QoS class A for UL data unit y, for example, if a DL data unit x is not successfully received.

A condition may be bound for a period of time (e.g., once satisfied). The condition may considered satisfied until the period of time (e.g., configured or predetermined) has elapsed. A differentiated QoS class may apply to the data unit, for example, while the condition is met during the period of time. The data unit is associated with a default QoS class or a reverted QoS class that was assigned before the condition was met, for example, once the period expires. A condition may be bound to a subset of data flows (e.g., a QoS flow, data unit set, a DRB, LCH, LCG, PDU set, etc.). The WTRU may determine that the condition is applied for a set of data flows (e.g., only for the applicable set of data flows, e.g., which may be configured by higher layer signaling) and the associated QoS class may be applied for the data unit, for example, once the condition is satisfied. A condition may be bound to a subset data types (e.g., control, user data, system data, intelligence data (e.g., AI/ML), positioning data, sensing data). Once satisfied, the WTRU may determine that the condition is applied for the applicable set of data type (e.g., only for the applicable set of data type, e.g., which may be configured by higher layer signaling) and the associated QoS class may be applied for the data unit. A condition may be bound to a subset of device capability. A condition may be bound to a subset of uplink grants, grant types (e.g., dynamic vs. semi-static/configured grants), a subset of grant indication properties, and/or a property of the grant scheduling indication (e.g., the DCI indication or as a function of the DCI scheduling parameters).

Details associated with QoS-aware inter-flow prioritization and shaping may be provided herein. QoS-aware inter-flow prioritization and/or shaping may be performed and/or enabled.

Traffic shaping patterns (e.g., UL traffic shaping parameters) may be determined (e.g., dynamically determined).

A WTRU may receive configuration information indicating (e.g., may be configured) per data flow (e.g., LCH) a set/policy (e.g., multiple sets/policies) of UL traffic shaping parameter(s) (e.g., r, b, P, BSD). The WTRU may determine the applicable set of parameters to update a traffic shaping bucket for a given flow, for example, based on the type of data (e.g., control, data, sensory, or ML) and/or the PDU priority within the flow (e.g., gating PDU, video frame meta data, or video defining frame)]

In examples, the WTRU may be configured with a UL traffic shaping envelope (e.g., plurality of UL traffic shaping envelopes). A (e.g., each) envelope may include a set of configured parameters for shaping UL traffic, for example, which may include a fill rate (e.g. r or PBR), a bucket size (BSD), a short-term fill rate for a secondary bucket (P), and/or a bucket water level update period. An envelope may be determined, for example, based on the burst size and/or the interpacket arrival periodicity. An envelope may be based on one or more traffic shaping and inter-flow prioritization policy, for example, including one or more of: a leaky bucket, a dual leaky bucket, the LCP procedure, shortest remaining time first, highest static priority first, first in first out, and/or no shaping (e.g., flow is not limited or limited only to the size of the grant). The WTRU may be configured with a default envelope (e.g., first envelope) and one or more non-default envelopes, for example, for a (e.g., each) data flow.

For a (e.g., each) treatment profile (e.g., RAN QoS treatment profile), the WTRU may be configured with associated UL traffic shaping envelope(s) that may be applicable for data of such QoS treatment profile. For a (e.g., each) QoS class, the WTRU may be configured with associated UL traffic shaping envelope(s) that are applicable for data units tagged with such QoS class. The WTRU may be (e.g., alternatively) configured with associated UL traffic shaping envelope(s) that are applicable for data from such flow, for example, for a (e.g., each) data flow (e.g., LCH, DRB, or PDU set).

The WTRU determines the applicable set of parameters and/or a shaping policy, for example, based on reception of an UL grant. The WTRU may determines the applicable set of parameters and/or a shaping policy, for example, based on a condition or the QoS class and/or the RAN QoS treatment profile associated with the data in the WTRU buffer (e.g., as described herein). For example, the WTRU may determine the applicable set of parameters and/or a shaping policy based on one or more of the following: a packet type (e.g., inclusion of a systematic data, high priority data, or a gating packet); interaction with system/sensory data; a transport layer protocol (e.g., TCP ACK, out of order packets, etc.); a reception of an indication from higher layers (e.g., from application), for example, indicating to prioritize such packet (e.g., such packet needs to be prioritized) ahead of other buffered packets in the queue for such data flow; a function of the QoS class associated with the data unit, QoE level of the service, or the QoS treatment profile; etc.

The WTRU may shape traffic associated with the default QoS class according to the default envelope configured for the data flow. The WTRU may shape traffic associated with a non-default QoS class according to the non-default envelope(s) configured for the data flow and/or the QoS class. The WTRU may be configured with a subset of QoS classes for which an alternate shaping envelope may be applied.

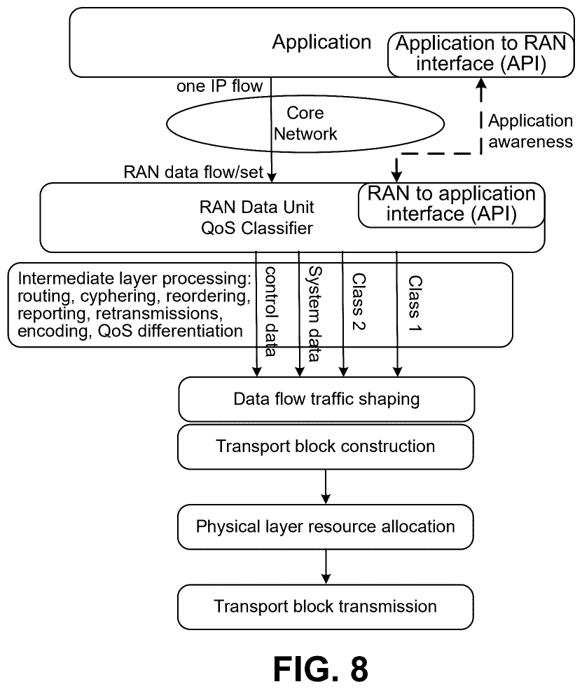

FIG. 8 illustrates an example of traffic shaping for a data flow.

In examples, the WTRU may be configured with a periodic or gating traffic service. For a gating data unit, the WTRU may set the bucket fill rate “r” of the non-default envelope (e.g., by updating Bj to Bj+ (r′ x time since Bj was last updated). The WTRU may reinitialize the bucket to b′. The WTRU may assume (e.g., temporarily assume) a different bucket size according to (BSD′ x r′), e.g., for allocating resources (e.g., only for allocating resources) to a data unit with a non-default QoS class or a data unit that is not using the default envelope configured for the data flow. Such may enable the WTRU and the NW to meet scheduling of such gating PDU. For other non-gating PDUs, the WTRU may use a lower value for b and/or r (e.g., the default values configured for the default envelope). The WTRU may maintain a single traffic shaping bucket, for example, even though it is shaping traffic differently for different types of data units (e.g., of different QoS classes).

In examples, the WTRU may be configured with a video service, for example, for systematic frames (e.g., that may be received (e.g., need to be received) at the application layer before processing any other frames). The WTRU may set the bucket fill rate “r” of the non-default envelop (e.g., by updating Bj to Bj+ (r′ x time since Bj was last updated). The WTRU may reinitialize the bucket water level (Bj) to b′. The WTRU may temporarily assume a different bucket size according to (BSD′ x r′). For other video frames, the WTRU may use a lower value for b and/or r (e.g., the default values configured for the default envelope).

In examples (e.g., alternative examples), the WTRU may maintain and buffer data units per UL traffic shaping envelope (e.g., one buffer queue per shaping envelope). The WTRU may serve data bits to a grant from such buffer in a FIFO fashion or by order of QoS class. The WTRU may maintain and buffer data units per QoS class (e.g., one buffer queue per QoS class). The WTRU may serve data bits to a grant from such buffer in a FIFO fashion or by criteria metric from those used to assign the QoS class (e.g., earliest deadline first, static priority, etc.), e.g., as described herein for the criteria.

Within a buffer queue of backlogged data units, the WTRU may serve data (e.g., by allocating a data unit to an uplink grant) as a function of QoS class priority (e.g. highest priority first, lowest QoS class value first, etc.), for example, if (e.g., possibly only if) the WTRU and/or the data flow is configured to allow out of order transmission of data units. The WTRU may serve data in a FIFO manner, for example, if the WTRU is configured to deliver/transmit data in order (e.g., by sequence number). The WTRU may indicate the SN gap or an indication that it is transmitting an out of order packet (e.g., within the buffer queue of a data flow, a traffic shaper, or a QoS calls buffer), for example, as part of header information of the out of order data unit or part of a control element or buffer status report.

The WTRU may update (e.g., as described herein) the shaping bucket (e.g., existing shaping bucket), for example, for a determined non-default envelope applicable to a given data unit. For example, a value b′ or a filling rate r′ may be determined from the applicable non-default envelope configuration. The WTRU may update the bucket water level such that it is equal to b′ (e.g., if configured) or equal to “Bj+=r′ multiplied by {time since Bj was last updated or an update period configured for the envelope}.

UL traffic shaping may be associated with network control. The network may control UL traffic shaping.

A UL traffic shaping envelope (e.g., applicable UL traffic shaping envelope) may be signaled (e.g., dynamically signaled), for example, by a network.

A WTRU may be configured per data flow (e.g., LCH) with multiple sets/policies of UL traffic shaping parameters (e.g., r, b, P, BSD, Bj update period). The WTRU may determine the applicable set of parameters to update a traffic shaping bucket for a given flow, for example, as a function of the UL shaping policy signaled or configured for the grant or grant type.

From the plurality of UL traffic shaping envelopes configured for a data flow or a WTRU, the WTRU may receive an indication from the network (e.g., downlink control information (DCI), PDSCH dependent data unit, control element (e.g., MAC CE), RRC signaling, or reconfiguration) indicating to use a given envelope for a given UL grant, data type, grant type (e.g., a configured grant, a CG index, or all dynamic grants), or one or more data flow for which the envelope is applicable. The indication may be provided dynamically, for example, as an indication by DCI or determined from a property of scheduling of the UL grant.

The WTRU may apply the envelope for shaping UL traffic for the applicable data flow, bucket, grant, and/or data type. The WTRU may apply the envelope for shaping UL traffic for a given applicability period, for example, where the applicability period may be preconfigured semi-statically or dynamically signaled (e.g., in the DCI or MAC CE) to be applicable for a given period or for grants received in such period.

The WTRU may update (e.g., as described herein) the shaping bucket existing shaping bucket, for example, for an envelope (e.g., signaled envelope) applicable to a given grant. For example, if a value “b” or a filling rate “r” is signaled (e.g., either explicitly or implicitly determined from an ID of a preconfigured shaping envelope), the WTRU may update the bucket water level such that it is equal to “b” (e.g., if signaled) or equal to “B+=r′ times multiplied by {the time since Bj was last updated or an update period signaled (or determined from a value configured for the non-default shaping envelope that is indicated)}.

The WTRU may apply a non-default traffic shaping envelope (e.g., for a given flow or for the WTRU), for example, based on determining that the WTRU and/or the network is in energy saving/efficiency state (e.g., which may be signaled to the WTRU, for example, by DCI/MAC CE signaling).

In examples, if (e.g., when) a dependent DL data unit or data type is received, the WTRU may determine to use a non-default shaping envelope for shaping a dependent UL data unit (e.g., if/when receiving a dependent DL data unit possibly of a given QoS class (e.g., where there is a relation between UL and DL QoS classes). DL and UL data flow association may be configured. For example, the WTRU may reset Bj to a value b′ or update Bj, for example, according to a non-default shaping envelope rate r′. The WTRU may determine to use a non-default shaping envelope for shaping a UL data unit, for example, if (e.g., when) a control plan event is triggered (e.g., a mobility event, a BFD value, BFR, or an RLM event (e.g., based on value of an RLM counter or a BFD counter)).

UL traffic shaping parameters may be controlled by the NW or under NW control.

For a given UL traffic shaping envelope (e.g., a bucket for a given flow, QoS class, or for the MAC entity/WTRU), the WTRU may receive a shaping control indication from the network (e.g., a downlink control information, DCI, control element (e.g., MAC CE), RRC signaling, or reconfiguration) indicating a change in a preconfigured shaping parameter (e.g., r, b, P, bucket size, number of applicable buckets, and/or envelope shaper). The indication may be provided (e.g., dynamically) as an indication by DCI or determined from a property of scheduling of the UL grant. The indication may include an ID of a given shaping bucket, a data flow, or a QoS class for which the change is applicable.

The WTRU may apply the indicated parameters for traffic shaping persistently (e.g., until it receives another indication changing the parameters), for example, once the shaping control indication is received. The WTRU may (e.g., alternatively) apply the indicated shaping parameters for a period (e.g., only for a given applicability period), for example, where the period (e.g., applicability period) may be preconfigured semi-statically or dynamically signaled (e.g., in the DCI or MAC CE) to be applicable for a given period or for grants received in such period.

In examples, the network may indicate to set/top up the bucket water level (e.g., Bj) to a given indicated level, by a given configured offset, an offset related to the TBS of the grant (e.g., possibly indicated grant), the bucket size of the current bucket, or to the initialization bucket water level “b” associated with the current envelope in use or an indicated envelope. Such update may be applicable to a given grant, data unit, QoS class, or a limited applicability period.

In examples, the network may indicate to update the bucket water level (e.g., Bj) to a given indicated rate (e.g., where the WTRU updates the bucket level to Bj=Bj+indicated rate x time since Bj was last updated (e.g., the update period)), a preconfigured rate, a rate associated with the data flow, a rate associated with the RAN QoS treatment profile (e.g., associated with buffered data units), and/or the rate associated with an indicated envelope. Such update may be applicable to a given grant, data type, data unit, QoS class, or a limited applicability period.

UL traffic shaping may include exceptions from UL traffic shaping. For example, an exception from UL traffic shaping may be determined.

The WTRU may determine an exception to UL traffic shaping (e.g., to exceptionally violate UL traffic shaping). For example, the WTRU may determine to allocate resources beyond the bucket level or add an offset to the current water level (e.g., as an exception to UL traffic shaping). The offset to the current water level may be added as a function of: inclusion of a systematic, high priority, or a gating packet. For such packets, the WTRU may prioritizes them ahead of other packets in the data flow buffer ahead of it.

Details associated with exceptions from traffic shaping may be provided herein.

In examples, the WTRU may (e.g., based on reception of a UL grant) perform one or more of the following: allocates bits and/or serve one or more data units from a data flow beyond the water level of the UL shaping envelope (e.g., transmit non-compliant data, causing the water level “Bj” to be negative”); increase the value of the water level by the amount of non-compliant data bits allocated to the grant or by a preconfigured value; etc.

Exceptions from traffic shaping may be based on a condition or the QoS class and/or the treatment profile (e.g., RAN QoS treatment profile) associated with the data in the WTRU buffer (e.g., as described herein). The exceptions from traffic shaping may be based on one or more of the following: a packet type (e.g., inclusion of a systematic data, high priority data, or a gating packet); an interaction with system/sensory data; a transport layer protocol (e.g., TCP ACK, out of order packets, etc.); a reception of an indication from higher layers (e.g., from an application) indicating that such packet may be (e.g., need to be) prioritized ahead of other buffered packets in the queue for such data flow; a function of the QoS class associated with the data unit, QoE level of the service, or the QoS treatment profile; a prohibit duration (e.g., timer) for such exception being expired.

The WTRU may allocate enough bits in the uplink grant to accommodate the transmission of such data unit (e.g., even if the size (data unit)>shaping water level “Bj”), for example, based on reception of a data unit of a high priority/low latency data unit associated with a non-default QoS class. The WTRU may be configured with a subset of QoS classes for which such exception is valid. The WTRU may reduce the value of Bj to a negative value or reduce Bj by the amount of over allocated bits. The WTRU may (e.g., alternatively) increase the value of Bj (e.g., as a one time exception) to accommodate the transmission of such data unit, for example, where Bj is increased to the size of the data unit (e.g., instead of r multiplied by the update period). In examples, data units of a given QoS class (e.g., classes with values less than or greater than a threshold) may be exempted from traffic shaping.

The WTRU may (e.g., be allowed to) apply this method per period (e.g., only once per period), e.g., a prohibit period (e.g., which may be configured or predefined or determined as a function of the QoS parameters associated with the data flow). The WTRU may start tracking a probit time/duration (e.g., via a timer), for example, after the WTRU applies such method (e.g., either serving bits beyond Bj for the data flow or adding an offset to Bj). The WTRU may transmit complied data (e.g., only transmit complied data) limited by the traffic shaper (e.g., Bj cannot be negative and/or no offsets can be artificially added to Bj), for example, if the prohibit duration is running/active (e.g., timer is running). The WTRU may (e.g., be allowed to) apply this method if (e.g., only) the data unit delay deadline (e.g., remaining time) is less than a threshold. The WTRU may (e.g., be allowed to) apply this method (e.g., only) if the priority/importance of the data unit is high/higher than a threshold.

Within a buffer queue of backlogged data units, the WTRU may serve data using this method (e.g., by allocating a data unit beyond Bj or by adding an offset to Bj) as a function of QoS class priority (e.g., highest priority first, lowest QoS class value first etc.), for example, if (e.g., possibly only if) the WTRU and/or the data flow is configured to allow out of order transmission of data units. For example, the WTRU may apply an exception for filling order of data units/SDUs from a given data flow as a function of priority or QoS class (e.g., rather than FIFO), e.g., as a function of the data unit's delay bound, remaining time till the delay bound, importance, data type, or whether it is a different transmission (e.g., new transmission) or a retransmission.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU) comprising,
a processor configured to:
receive configuration information for a data flow comprising a first set of traffic shaping parameters associated with a first QoS classifier and a second set of traffic shaping parameters associated with a second QoS classifier;
receive an uplink grant for transmission;
determine a QoS classifier associated with a data packet, wherein the QoS classifier is the first QoS classifier or the second QoS classifier;
multiplex data associated with the data flow based on a set of traffic shaping parameters associated with the determined QoS classifier, wherein the set of traffic shaping parameters is one of the first set of traffic shaping parameters or second set of traffic shaping parameters; and
send the multiplexed data using the uplink grant.

2. The WTRU of claim 1, wherein the determined QoS classifier associated with the data packet is associated with one or more of a packet type, a priority, quality of service (QoS) treatment profile, a quality of experience (QoE) treatment profile, a data interaction, or a transport layer protocol.

3. The WTRU of claim 1, wherein the processor is further configured to:
determine whether a condition associated with the data packet is satisfied, wherein the determined QoS classifier is determined based on the determination of whether the condition associated with the data packet is satisfied.

4. The WTRU of claim 1, wherein the processor is further configured to:
receive, from a network entity, an indication associated with traffic shaping, wherein the set of traffic shaping parameters for the data flow is determined based on the indication associated with traffic shaping.

5. The WTRU of claim 4, wherein the indication is received via at least one of downlink control information (DCI) or a signal from the network entity.

6. The WTRU of claim 4, wherein the indication associated with traffic shaping indicates a duration to apply the determined set of traffic shaping parameters.

7. The WTRU of claim 4, wherein the indication associated with traffic shaping is applicable to the received uplink grant.

8. The WTRU of claim 1, wherein the set of traffic shaping parameters is associated with one or more of a rate, a burst size, a peak rate, a bucket size, a number of buckets, or a shaping envelope.

9. The WTRU of claim 1, wherein the set of traffic shaping parameters is associated with one or more of a quality of service (QoS) treatment profile or a quality of experience (QoE) treatment profile.

10. The WTRU of claim 1, wherein the uplink grant is further determined based on whether the data packet is associated with a traffic shaping exception, wherein the processor is further configured to:
determine that the data packet is associated with a traffic shaping exception based on one or more of a characteristic associated with the data packet or a condition associated with the data packet.

11. A method comprising:
receiving configuration information for a data flow comprising a first set of traffic shaping parameters associated with a first QoS classifier and a second set of traffic shaping parameters associated with a second QoS classifier;
receiving an uplink grant for transmission;
determining a QoS classifier associated with a data packet, wherein the QoS classifier is the first QoS classifier or the second QoS classifier;
multiplexing data associated with the data flow based on a set of traffic shaping parameters associated with the determined QoS classifier, wherein the set of traffic shaping parameters is one of the first set of traffic shaping parameters or second set of traffic shaping parameters; and
sending the multiplexed data using the uplink grant.

12. The method of claim 11, wherein the determined QoS classifier associated with the data packet is associated with one or more of a packet type, a priority, quality of service (QoS) treatment profile, a quality of experience (QoE) treatment profile, a data interaction, or a transport layer protocol.

13. The method of claim 11, wherein the method further comprises:
determining whether a condition associated with the data packet is satisfied, wherein the determined QoS classifier is determined based on the determination of whether the condition associated with the data packet is satisfied.

14. The method of claim 11, wherein the method further comprises:
receiving, from a network entity, an indication associated with traffic shaping, wherein the set of traffic shaping parameters for the data flow is determined based on the indication associated with traffic shaping.

15. The method of claim 14, wherein the indication is received via at least one of downlink control information (DCI) or a signal from the network entity.

16. The method of claim 14, wherein the indication associated with traffic shaping indicates a duration to apply the determined set of traffic shaping parameters.

17. The method of claim 14, wherein the indication associated with traffic shaping is applicable to the received uplink grant.

18. The method of claim 11, wherein the set of traffic shaping parameters is associated with one or more of a rate, a burst size, a peak rate, a bucket size, a number of buckets, or a shaping envelope.

19. The method of claim 11, wherein the set of traffic shaping parameters is associated with one or more of a quality of service (QoS) treatment profile or a quality of experience (QoE) treatment profile.

20. The method of claim 11, wherein the uplink grant is further determined based on whether the data packet is associated with a traffic shaping exception, wherein the method further comprises:
determining that the data packet is associated with a traffic shaping exception based on one or more of a characteristic associated with the data packet or a condition associated with the data packet.
